(19) United States
(12) Patent Application Publication
(10) Pub. No.: US 2016/0004822 A1
(43) Pub. Date: Jan. 7, 2016

(54) Medical information system and a method for promoting patient compliance and for selectively populating an electronic medical record system with data

(71) Applicant: Sanjay Jadhav Patil, Irvine, CA (US)

(72) Inventor: Sanjay Jadhav Patil, Irvine, CA (US)

(21) Appl. No.: 14/120,860

(22) Filed: Jul. 3, 2014

(51) Int. Cl. G06F 19/00

(52) U.S. Cl. CPC G06F 19/322

(57) ABSTRACT

A system 50 and methodology 80 which automatically populates a patient's medical record with data from a bio-data collector and which increases the likelihood of compliance with a plan of treatment.

### GENERAL BACKGROUND

1. Field of the Invention

The present invention generally relates to a medical information system and a method for promoting patient compliance, and for selectively populating an electronic medical record system with data, and more particularly to a medical information system which is adapted to allow various types of information to be selectively communicated to and populated within an electronic medical records computer system, which further allows other information to be selectively and communicatively transmitted to a patient, which may be used to increase the likelihood of patient compliance, and which may comprise a clearinghouse for medical information.

2. Background of the Invention

The use of electronic medical record type computer systems has been governmentally mandated as part of the health care system reformation occurring in the United States. A great many providers of such systems have emerged, each with different and unique data processing methodologies, but providing the ability to electronically store and allow selective access to the medical records of various individuals (i.e., patients). Some non-limiting examples of electronic medical record systems include the system commonly referred to as “Epic®” and discussed at www.epicmedicalrecords.com and the Centricity® system provide by The General Electric Corporation. The use of these systems has arguably increased overall patient safety and increased medical service delivery efficiency.

The aforementioned reformation has further necessitated the need to monitor chronically ill patients (and recently discharged patients) at remote locations from a hospital (e.g., such as in the respective homes of these patients). That is, under this reformation, hospitals are monetarily penalized for the readmission of previously discharged patients and for frequently having chronically ill patients enter the hospital facilities for testing or other procedures. In response to this need, many provides of bio-data devices have emerged and such devices, which are typically resident within the home of a chronically ill patient, capture and transmit data (often termed “bio-data”) associated with certain physical characteristics of the patient (e.g., weight , blood sugar level, blood pressure, and blood oxygen level).

While these devices do provide much needed bio-data, they are not adapted to be directly and communicatively coupled to the electronic medical records computer systems and therefore require the hospitals and other medical providers to use two separate systems to manage patient care (the electronic medical record systems and the new bio-data systems), thereby undesirably eliminating or degrading the benefits sought to be achieved by a single electronic medical records system.

Some attempts have been made to manually input the bio-data into the electronic medical records system. However, these attempts not only increase overall cost and complexity, they also increase the probability of errant entry. Thus, the manual entry of all of this data also greatly degrades and/or eliminates the very benefits that the electronic medical record systems were to provide to health care providers.

Moreover, many patients do not comply with their plan of care (e.g., they do not take their prescribed medication), thereby placing their health at risk and increasing the overall cost of care (e.g., patients who do not follow their plan of care are far more likely to be readmitted to the hospital). Since there are no effective systems in place to monitor such non-compliance, overall health care costs are detrimentally affected (e.g., by undesirable readmissions and costly follow on care).

These and other drawbacks and disadvantages are addressed by the various inventions of the present invention.

### SUMMARY OF THE INVENTION

It is a first non-limiting object of the present invention to provide a medical information system which overcomes some or all of the various disadvantages and drawbacks of the present invention.

It is a second non-limiting object of the present invention to provide a medical information system which overcomes some or all of the various disadvantages and drawbacks of the present invention and which allows dissimilar bio-data devices to be communicatively coupled to a variety of electronic medical records computer systems.

It is a third non-limiting object of the present invention to provide a method which overcomes some or all of the various disadvantages and drawbacks of the present invention and which allows increases the probability of patient compliance.

According to a first non-limiting aspect of the present invention, a medical information system is provided and includes a first portion which receives information regarding the medical condition of an individual; and a medical record portion which is remote from the first portion, which includes a record of the medical condition of the individual, which receives the information, and which places the received information within the record of the individual.

According to a second non-limiting aspect of the present invention, a medical information system is provided and includes a first bio-data collection device; a second bio-data collection device which is dissimilar from the first bio-data collection device; an electronic medical records computer system having first and second medical records which are respectively and uniquely associated with first and second individuals; a middleware assembly which is in communication with the electronic medical records computer system and with the first and second dissimilar bio-data collection devices and which receives first information from the first bio-data collection device and which thereafter communicates the first information to the electronic medical records computer system wherein the first information is placed in the first medical record and which further receives the second information from the second bio-data collection device and which thereafter communicates the second data to the electronic medical records computer system wherein the second information is placed in the second medical record.

According to a third non-limiting aspect of the present invention, a method for promoting compliance by a patient is provided. Particularly, the method comprises the steps of determining whether a plan of care exists; automatically querying a provider to determine whether the plan of care has been complied with; sending the patient a reminder if the plan of care has not been fulfilled; and sending an advertisement from the provider to the patient.

These and other features, aspects, and advantages of the present invention will become apparent from a reading of the detailed description of the preferred embodiment of the invention, including the subjoined claims, and by reference to the following drawings.

### BRIEF DESCRIPTION OF THE DRAWINGS

FIG. 1 is a block diagram of a typical electronic medical record computer system.

FIG. 2 is a block diagram of the electronic medical record computer system of FIG. 1 in communicative combination with a remote bio-data device.

FIG. 3 is a block diagram of the electronic medical record computer system and remote bio-data device shown in FIG. 2 in combination with the medical information system which is made in accordance with the teachings of the preferred embodiment of the invention.

FIG. 4 is a block diagram of a typical packet of data which is transmitted by a bio-data device.

FIG. 5 is a flow chart which illustrates the sequence of steps associated with the methodology of the preferred embodiment of the invention.

### DETAILED DESCRIPTION OF THE PREFERRED EMBODIMENT OF THE INVENTION

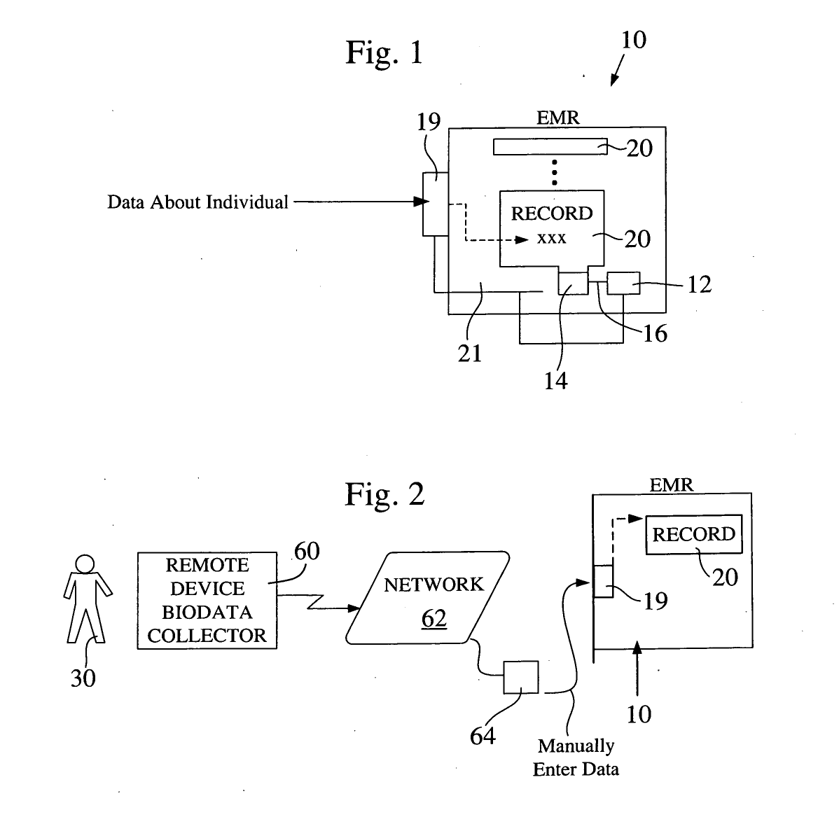

Referring now to FIGS. 1 and 2, there is shown a typical electronic medical records computer system 10 (which may comprise the afore-described systems) and which includes at least one processor 12 acting under stored control and a memory assembly 14 which is communicatively coupled by a bus 16 to the at least one processor 12 and which contains the operational code and the patient data which is resident within the system 10. The electronic medical records system 10 also includes an input/output portion 19 which is coupled to memory portion 14 and to the at least one processor 12 by bus 21 and which allows information to be received by the at least one processor 12 and the memory portion 14 and to be transmitted by the at least one processor 12. In one non-limiting embodiment, the input/output portion 19 comprises a transmitter and receiver assembly of the type which allows the assembly 10 to be communicatively coupled to the Internet, although other hardware and/or software architectures may be implemented. Further, in one non-limiting embodiment the at least one processor 12 comprises a processor manufactured and/or supplied by the Intel® Corporation and commonly referred to as an “I7”, although other processors may be utilized.

Particularly the memory assembly 14 includes a plurality of medical records 20 of individual patients, and such contained medical records are accessible by the at least one processor 12 by use of the bus 16 and may be written into (e.g., updated) by and exported to certain medical providers and others by the use of input/output portion 19 and the bus 21.

The respective medical records 20 include information concerning the respective diagnosed medical condition of the respective patients along with the prescribed treatment, such as required medication and other prescribed activities, such as physical therapy. Thus, each patient who is attended to by the use of this electronic medical record system 10 has a medical record which is resident within the memory 14 and each such record includes a plan of treatment for the respective patient. This information has been typically and manually entered into the system 10 by someone in the offices of the medical provider and this system 10 is then accessible by personnel in the office of the medical provider as well as other authorized individuals and entities. Normally a typical patient's medical record is updated, by the patient's health care provider, each and every time that the patient is attended to by that healthcare provider. Such updates include the identification of prescribed medicines, changes in medical conditions, scheduling of future visits/treatments, drug prescriptions, and other medically related items and patient identification items (e.g., change of an address).

As was previously discussed, with the advent of new health care legislation, it is becoming increasingly advantageous to monitor both chronically ill and/or recently discharged patients 30 from their respective homes. Thus, there are proliferating many diverse types of remote bio-data collection devices, such as bio-data collector 60, which collect data from a chronically ill patient and/or recently discharged patient 30 , such as the weight associated with a patient 30 having congestive heart failure or the insulin levels in a diabetic, and which transmits the information, by use of a network (e.g., a cellular telephone type network) 62 to a dedicated receiver 62 which must be read by a health care provider. One such non-limiting example of such a bio-collection device is the Vitalink™ device which is discussed in the website known as www.vg-bio.com. Nothing in this application is meant to limit the use of bio-collection devices to certain devices and, in fact, the inventions are purposely made to be used with a diverse type of bio-collector devices and various other types of information generating devices, not necessarily of the bio collector type. The received information must then be manually entered into the record of the patient 30 which is resident within the system 10 or used in combination with the electronic medical record system 10.

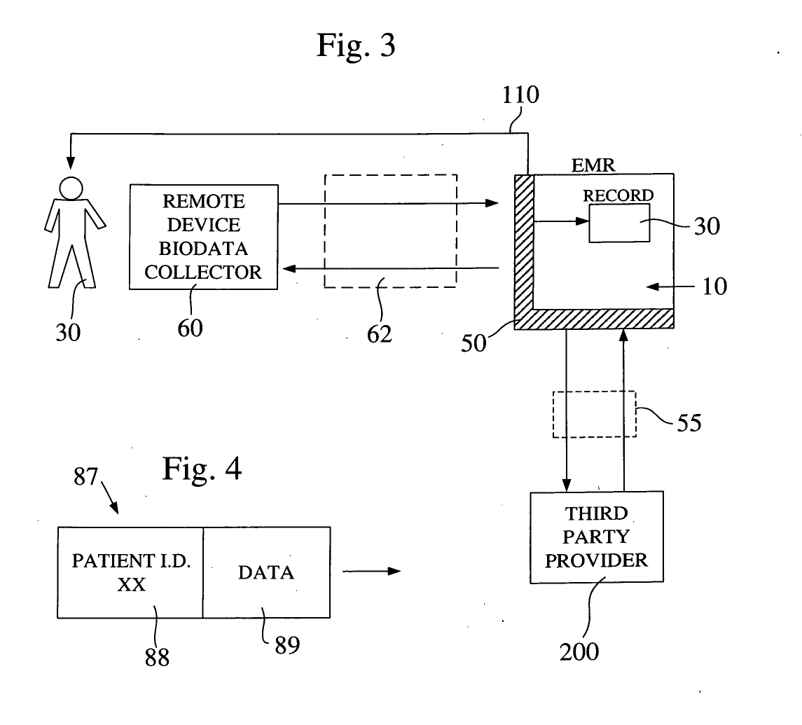

Referring now to FIG. 3, in accordance with the teachings of the preferred embodiment of the invention, there is shown the software or “middleware” 50 of the most preferred embodiment of the invention. The term “middleware”, in this description, refers to software which operatively couples two entities (the collectors or devices 60 and the system 10).

Particularly, the middleware 50 may comprise software which is resident within the memory assembly 14 and accessible by the processor assembly 12. The middleware 50 is in communication with the bio-data collector 60 by the use of the network 62, such as a cellular telephone network, and receives the information associated with the patient 30 and automatically populates the medical record of the patient 30, resident within the system 10, with the received information. The term “automatically”, in this context, means without physical entry by someone. The middleware 50 and the electronic medical records system 10 may cooperatively form a single computer system.

In one non-limiting architectural embodiment, the bio-data device 60 transmits a packet of information 87 which includes a header or portion 88 which uniquely identifies the patient 30 and a second portion 89 which includes the bio-data which was generated (e.g., the measured weight of the patient 30). The packet 87 is received, through the network 62, by the input/output portion 19 and placed within the memory portion 14. Thereafter, the at least one processor 12 parses the received packet 87 and first notes the identity of the patient 30 and then recognizes the received information 89. The at least one processor 12 then locates the record of the patient 30 which is resident within the memory 14 and places the data 89 into that record.

For each dissimilar bio-data collector, the at least one processor 12 notes the location in each received and respective data packet which notes the unique identification of the patient 30 and the location of the received information. Once these two portions of each of the respectively received packets are parsed, the processor populates correct and respective medical records, with the respectively parsed data, in the manner which has been specified above. Depending upon the information, the patient may be contacted by a nurse or other health care professional in order to receive instructions or to convey other information. This informational feedback will reduce the likelihood of having the patient be quickly readmitted while allowing the healthcare team to quickly respond to emergency conditions.

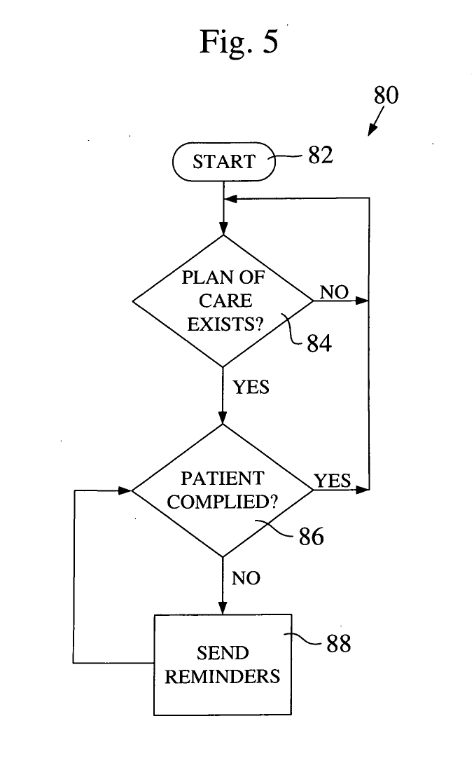

The middleware 50 may also be in communication with a third party provider of goods and services, such as a pharmacy 200, and may be used to increase the likelihood of compliance by the patient 30 of the ordered medical treatment. Such compliance monitoring is shown by the methodology set forth in FIG. 5.

Particularly, the compliance monitoring methodology 80 includes a first step 82 in which the methodology begins for the patient 30. Step 84 follows step 82 and, in this step, the middleware 50 recognizes whether a plan of care exists and is resident within system 10 for that patient 30. If no plan of care exists, then step 82 is repeated until such a plan of care is found. Alternatively, step 84 is followed by step 86 in which it is determined whether the patient 30 has complied with the discovered plan of care. Particularly, the middleware 50 communicates, by use of network 55 (which may be similar to network 62) , with a third party provider 200 which provides goods and/or services necessary to having the patient 30 comply with the treatment plan. Some non-limiting examples of the third party provider include a pharmacy and a physical therapy treatment facility. The middleware 50 will query such a third party provider 100 to determine whether the ordered goods and /or services have actually been obtained by the patient 30. If such goods and services have been obtained, then step 86 is followed by step 84. Alternatively, step 86 is followed by step 88 in which the patient 30 is sent a reminder by the middleware 50 through a network 110 (which may be similar to networks 55 and 62) non-limiting examples of such reminders include SMS text and email messages. Step 88 is followed by step 86.

It should be understood that the middleware 50 will receive medical data from any sort of device or source, not just a bio data device or source, and will selectively place the received data into the medical record which is associated with the individual to whom the received data pertains.

It is to be understood that the various inventions, as delineated in the following claims, are not limited to the exact construction and methodology which has been delineated above, but that various changes and modifications may be made without departing from the spirit and the scope of these inventions as they are set forth below. What has been described, in part, is a informational exchange invention in which information is exchanged between an electronic medical records management system, a patient, and at least on third party provider of goods and services, Such an exchange is enabled by middleware 50 and, in one non-limiting embodiment of the invention, the owner or operator of middleware 50 may exact payment for each such informational exchange and therefore act as a clearinghouse for such informational exchanges.

What is claimed:

1. A medical information system comprising a first portion which receives information regarding the medical condition of an individual; and a medical record portion which is remote from said first portion, which includes a record of the medical condition of said individual, which receives said information, and which places said received information within said record of said individual.

2. The medical information system of claim 1 wherein said information comprises bio-data.

3. A medical information system comprising a data source; a second data source which is dissimilar from said first data source; an electronic medical records computer system having first and second medical records which are respectively and uniquely associated with first and second individuals; a middleware assembly which is communication with said electronic medical records computer system and with said first and second dissimilar data source and which receives first information from said first data source and which thereafter communicates said first information to said electronic medical records computer system wherein said first information is placed in said first medical record and which further receives said second information from said second data source and which thereafter communicates said second data to said electronic medical records computer system wherein said second information is placed in said second medical record.

4. The medical information system of claim 3 wherein said middleware assembly is in further communication with a second computer system, which receives information from said second computer system and which communicates said information to said individual.

5. The medical information system of claim 4 wherein each of said first and second data sources each comprise respective bio data devices.

6. A method for promoting compliance by a patient, said method comprising the steps of determining whether a plan of care exists; automatically querying a provider to determine whether the plan of care has been complied with; sending the patient a reminder if said plan of care has not been fulfilled; and sending an advertisement from said provider to said patient.
